(19) United States
(12) Patent Application Publication
(10) Pub. No.: US 2025/0066624 A1
(43) Pub. Date: Feb. 27, 2025

(54) COATING COMPOSITION

(71) Applicant: Dow Global Technologies LLC, Midland, MI (US)

(72) Inventors: Yinzhong Guo, Pearland, TX (US); Ibrahim Eryazici, Phoenixville, PA (US); Himal H. Ray, Collegeville, PA (US); Yuanqiao Rao, Berwyn, PA (US); Amira A. Marine, Missouri City, TX (US); Manesh Nadupparambil Sekharan, Freeport, PA (US); Vinita Yadav, Royersford, PA (US); Christopher I. Gandy, Houston, TX (US)

(73) Assignee: Rohm and Haas Company, Collegeville, PA (US)

(21) Appl. No.: 18/281,129

(22) PCT Filed: Feb. 2, 2022
(86) PCT No.: PCT/US2022/014943

§ 371 Date: Sep. 8, 2023

Related U.S. Application Data
(60) Provisional application No. 63/164,102, filed on Mar. 22, 2021.

(51) Int. Cl. C09D 7/42; C08J 7/04; C09D 5/02; C09D 7/40; C09D 7/65; C09D 7/80; C09D 147/00

(52) U.S. Cl. CPC C09D 7/42; C08J 7/0427; C09D 5/024; C09D 7/65; C09D 7/66; C09D 7/80; C09D 147/00; C08J 2333/04; C08J 2367/02

(57) ABSTRACT

An aqueous matte finish coating composition, including: at least one acrylic dispersion with a plurality of crosslinked particles comprising a plurality of first acrylic particles having a median weight average particle size of less than or equal to 4 microns in diameter and a surface Young's modulus of greater than or equal to 450 megapascals; a process for producing the above aqueous matte coating composition; and a coated substrate coated with a dry coating made using the above aqueous matte coating composition.

### FIELD

The present invention is related to a coating composition; and more specifically, the present invention is related to a matte coating composition. The coating composition can be applied to film substrates to form a matte coated film for use in packaging applications.

### BACKGROUND

A matte finish for a film structure has been commonly used in packaging applications to add more functions to the packaging film, such as optical appearance, touch feeling or tactile response, ink and image protection for direct printing, improving packaging durability, and improving packaging processing. Most matte finishes are formulated from inorganic fillers such as silica or titanium oxide with polymer binders such as acrylic and polyurethane, either solvent-borne or waterborne. However, inorganic pigments present in a matte finish reduces the abrasion resistance and lowers the touch feeling of the film; and such pigments may deleteriously affect other performance properties of the film. Heretofore, polymeric organic bead particles have been used in matte coating formulations to resolve the adverse effects caused by inorganic pigments. For example, U.S. Patent Application Publication No. 20190315994A1, WO2020076577A1, and U.S. Provisional Patent Application Publication No. 63/122,686 disclose forming a coated substrate for packaging, by applying an aqueous matte coating composition containing acrylic polymer beads on film substrates. The above prior art references describe forming a matte coating product with a composition including acrylic beads larger than 4.5 microns size). However, the matte coating products disclosed in the above references can only be applied by gravure process due to the larger particle size beads which are too big to be applied by Flexographic and offset printing process, which are two processes that can be advantageously used in various packaging coating applications.

Additionally, matte finish coated film substrates prepared using inorganic pigments provide low color fidelity and weak abrasion resistance properties of overprinting vanish (OPVs); which are important performance attributes of coated films to the packaging industry; particularly, to provide a matte finish coated film that meets the need in primary packaging applications. Recently, a polyurethane (PU) beads-based matte finish has been developed that provides an excellent matte appearance and a soft touching property. However, the PU component of such varnishes (i.e., coating formulations) adds a significant high cost to manufacturing the matte coating formulation

Other matte coating formulations used for matte packaging applications require that the original formulations be modified or reformulated by individual packaging manufacturers to meet individual packaging manufacturers' specific application requirements unique to such individual packaging manufacturers. Also, some matte coating formulations provide a coating having a high coefficient of friction (COF). Some ready-to-use matte coating formulations have had limited success in providing performance improvements related to properties such as soft touch, color retention, abrasion resistance, and application rheology without having to reformulate the original formulation. However, the ready-to-use matte coating formulations still have a high COF and such formulations are only suitable for a gravure printing process due to the larger than 4.5 microns (μm) particle size acrylic beads used in the formulations and the use of a lower solid content. The formulations have a larger particle size and a low solids content which limits the application of the formulations by Flexographic printing and offset printing processes due to the lower material transfer efficiency from anilox roll to printing roll.

Therefore, there is a desire in the packaging industry to develop a matte coating formulation for use in all types of application processes including gravure, Flexographic printing, and offset printing processes. There is also a desire in the packaging industry to increase the performance of a matte coating. In addition, there is a desire in the packaging industry to provide a matte coating having a low COF.

### SUMMARY

In one embodiment, the present invention solves the above problems of the prior art, by formulating a water-based matte coating composition comprising polymeric multistage crosslinked beads with less than or equal to (≤) 4.0 μm average particle size (e.g., a 3 μm average particle size) with surface Young's modulus greater than or equal to (≥) 450 megapascals (MPa) as a raw material to generate a coating with a matte appearance instead of using larger than 4.5 μm size acrylic beads for producing coating formulations. In addition, the solid content of the present invention coating formulation is increased (e.g., greater than [>] 35 weight percent [wt %]) to improve the material transfer efficiency of Flexographic printing and offset printing processes.

In another embodiment, an aqueous matte finish coating formulation is prepared comprising a plurality of first acrylic particles having a median weight average particle size of ≤4 μm in diameter; and having a surface Young's modulus ≥500 MPa in one general embodiment.

In still another embodiment, the aforementioned multistage crosslinked 3 μm size beads formulation can be further formulated with (1) another multistage crosslinked beads smaller in size such as beads smaller than 1 μm size, (2) acrylic binders, and (3) a unique additives package to form a matte coating material which can deliver a low COF (e.g., less than [<] 1.0 COF-Coating/Coating-Static). And, the water-based matte coating composition of the present invention provides a coating with good properties such as a good matte appearance, abrasion resistance, color retention, and soft touch. In addition, the water-based matte coating composition of the present invention is not limited to using a gravure process; but instead, can be used with gravure including reverse gravure and rotary gravure; Flexographic printing; and offset printing processes. Additionally, the 3 μm size multistage crosslinked acrylic beads, having a higher solid content, increases the solid content of the finish formulation which improves the material transfer efficiency of Flexographic processing and offset printing. The present invention, related to the novel coating composition, resolves the process challenges and performance gaps of previous matte coating composition products.

In yet another embodiment, the present invention relates to a novel matte coating composition or formulation including multistage crosslinked acrylic bead dispersions, acrylic binders, and additives. The novel combination of the above components provides the scope for specially designed polymeric materials; and the polymeric materials' application processing rheology property and dried finish surface morphology. The matte finish of the present invention coating has beneficial performance properties such as matte appearance so low gloss at 60°, abrasion resistance, good adhesion, excellent color fidelity, excellent soft touch, and a low COF as well as the better shelf stability of the formulated compositions. In addition, the novel matte coating composition of the present invention can be used with several application processes such as gravure including reverse gravure and rotary gravure, Flexographic, and offset printing.

In other various embodiments, the present invention matte coating formulation may contain various additives such as different defoamers; different rheology modifiers; different wetting additives; and different slip additives such as silicone emulsion and wax dispersions to further improve the performance of the matte coating formulation. The matte coating formulation can be combined with, but not limited thereto, various one or more different water-dispersible post-crosslinking such as a poly-isocyanate added just before the coating is applied.

The matte coating composition of the present invention advantageously can be applied using gravure processing, Flexographic print, and offset print for making a matte packaging material for premium packaging. The coating composition of the present invention beneficially provides unique performance including for example, a soft touch, a low COF, color retention, abrasion resistance, anti-glare (lower gloss), and the like.

In other embodiments, the matte coating composition of the present invention advantageously can be applied onto polyolefin substrates to construct recyclable polyolefin packaging.

For example, in one broad embodiment, the matte finish formulation of the present invention includes: (A) at least one acrylic dispersion with multistage crosslinked particles having an average particle size of ≤4.0 μm with surface Young's modulus of ≥450 MPa; (B) at least one rheology modifier; (C) at least one defoamer; (D) at least one neutralization agent to adjust the pH of the formulation to a level of from 7.5 to 9.0; (E) at least one wetting additive; (F) at least one slip additive; and (G) at least one water-dispersible post-crosslinker.

In another embodiment, the matte finish formulation of the present invention includes, for example: (A) a combination of: (Ai) a first acrylic bead dispersion with multistage crosslinked particles with a first stage polymers phase having a glass transition temperature (Tg) of ≤20 degrees Celsius (C) and a second stage polymers phase having a Tg of ≥30° C., and average particle size of from 1 μm to 4.0 μm with surface Young's modulus of ≥450 MPa; (Aii) a second acrylic multistage crosslinked bead dispersion different from the first acrylic bead dispersion and having a first stage polymers phase having a Tg of ≤20° C. and a second stage polymers phase having a Tg of >30° C., and average particle size of from 0.2 μm to 0.99 μm; and (Aiii) a third acrylic binder emulsion different from the first and second acrylic bead dispersions and used as a binder having a Tg of from −30° C. to 60° C. and an z-average particle size distribution of from 0.05 μm to 0.3 μm; (B) at least one rheology modifier in a general embodiment and in one preferred embodiment the rheology modifier can include a combination of two or more different rheology modifiers; (C) at least one defoamer in a general embodiment and in one preferred embodiment the defoamer can include a combination of two or more different defoamers; (D) a neutralization agent to adjust the pH of the formulation to a pH level of from 7.5 to 9.0; (E) at least one wetting additive in a general embodiment and in one preferred embodiment the wetting additive can include a combination of two or more different wetting additives; (F) at least one slip additive in a general embodiment and in one preferred embodiment the slip additive can include a combination of two or more different slip additives; (G) a water dispersible polyisocyanate used as a post-crosslinker; and (H) optionally, water used as a diluent agent.

In still another embodiment, the matte finish formulation of the present invention includes, for example: (A) a combination of: (Ai) a first acrylic bead dispersion with multistage crosslinked particles with a first stage polymers phase having a Tg of ≤20° C. and a second stage polymers having a Tg of ≥30° C., and average particle size of from 1 μm to 4.0 μm with surface Young's modulus of ≥450 MPa at a loading level of from 30 dry wt % to 70 dry wt % based on the total dry weight of the formulation; (Aii) a second multistage crosslinked acrylic bead dispersions different from the first acrylic dispersion and with a first stage polymers phase having a Tg of ≤20° C. and a second stage polymers phase having a Tg of ≥30° C., and average particle size of from 0.2 μm to 0.99 μm at a loading level based on solid from 10 dry wt % to 40 dry wt % based on the total dry weight of the formulation; and (Aiii) a third acrylic emulsion different from the first and second acrylic dispersions and used as a binder having a Tg of from −30° C. to 60° C. and an average z-average particle size of from 0.05 μm to 0.3 μm at a use level of from 10 dry wt % to 30 dry wt % based on the total dry weight of the formulation; (B) at least one rheology modifier in a general embodiment and in one preferred embodiment the rheology modifier can include a combination of two or more different rheology modifiers at a total loading level of up to 2.0 dry wt % wherein the loading is based on the total dry weight of the formulation; (C) at least one defoamer in a general embodiment and in one preferred embodiment the defoamer can include a combination of two or more different defoamers at a loading level of up to 0.5 wt % based on the total dry weight of the formulation; (D) a neutralization agent to adjust the pH of the formulation to a pH level of from 7.5 to 9.0; (E) at least one wetting additive in a general embodiment and in one preferred embodiment the wetting additive can include a combination of two or more different wetting additives at a total loading level of up to 1.0 dry wt % wherein the loading is based on the total dry weight of the formulation; (F) at least one slip additive in a general embodiment and in one preferred embodiment the slip additive can include a combination of two or more different slip additives at a total loading level of up to 7.0 dry wt % based on the total dry weight of the formulation; (G) a water dispersible polyisocyanate used as a post-crosslinker at loading level of up to 10.0 dry wt % wherein the loading is based on the total dry weight of the formulation; and (H) optionally, water used as a diluent agent.

In yet another embodiment, the present invention includes a method for applying the above aqueous matte coating composition to a substrate, the method comprising: (I) forming the aqueous matte coating composition, comprising: (a) at least one acrylic bead having an average particle size of ≤4 μm with surface Young's Modulus of ≥450 MPa; (b) at least one polymer binder; and (c) at least one slip additive comprising a silicone emulsion and a wax dispersion; (d) a water dispersible post-crosslinker; (II) applying the aqueous matte coating composition to a substrate; and (III) drying, or allowing to dry the applied aqueous matte coating composition.

In even still another embodiment, the present invention includes a coated substrate coated with the above aqueous matte coating composition,

In even yet another embodiment, the present invention includes a packaging article made from the above aqueous matte coating composition.

### DETAILED DESCRIPTION

A “dispersion” herein means either polymeric crosslinked particles stabilized in a water matrix during polymerization; or wax and other additives dispersed in water by high-shear mixing.

An “emulsion” herein means an aqueous material made from free radical emulsion polymerization of unsaturated monomers.

A “matte finish”, with regard to a coating, herein means a low gloss; or an anti-glare layer coated on a substrate.

Unless stated to the contrary, implicit from the context, or customary in the art, all parts and percentages are based on weight, all temperatures are in° C., and all test methods are current as of the filing date of this disclosure.

The term “composition,” as used herein, refers to a mixture of materials which comprises the composition.

The term “particle size” for acrylic beads as used herein, refers to median weight average (D₅₀) particle size measured by Disc Centrifuge Photosedimentometer (DCP) described in Methods section.

The term “z-average particle size” for acrylic emulsion as used herein, refers to z-average (D_{z}) particle size measured by Malvern dynamic light scattering described in Methods section.

“Polymer” means a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities (for example, catalyst residues) may be incorporated into and/or within the polymer. A polymer may be a single polymer, a polymer blend or a polymer mixture, including mixtures of polymers that are formed in situ during polymerization.

The term “post-crosslinker” refers to a class of materials with more than two reactive chemical groups per molecule that can form a crosslinked network of stable chemical bonds during or after film formation.

The term “HDPE” refers to polyethylenes having densities >0.940 gram(s) per cubic centimeter (g/cm³) and up to 0.970 g/cm³, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 g/cm³ to 0.912 g/cm³, which are generally prepared with Ziegler-Natta catalysts, chrome catalysts, or single-site catalysts including, but not limited to, bis-metallocene catalysts and constrained geometry catalysts.

The terms “comprising.” “including.” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

In a broad embodiment, the present invention comprises a matte finish formulation or composition including, for example, (A) at least one acrylic bead dispersion with multistage crosslinked particles having an average particle size of ≤4.0 μm in diameter and surface Young's modulus ≥450 megapascal; (B) at least one rheology modifier; (C) at least one defoamer; (D) at least one neutralization agent to adjust the pH of the formulation to a level of from 7.5 to 9.0; (E) at least one wetting additive; (F) at least one slip additive; and (G) at least one water-dispersible post-crosslinker.

The acrylic dispersion, component (A) useful in the present invention can include one or more acrylic dispersion and emulsions.

In one preferred embodiment, the acrylic bead dispersion is a combination, blend or mixture of more than one dispersion; and in another preferred embodiment, the dispersion, component (A) is a combination of three dispersions or emulsions such as (Ai) a first acrylic bead dispersion, (Aii) a second acrylic bead dispersion; and (Aiii) a third acrylic emulsion.

Aqueous dispersions of multistage crosslinked acrylic beads can be prepared in a variety of ways, including those described in US Pat. Pub. 2013/0052454; U.S. Pat. Nos. 4,403,003; 7,768,602; 7,829,626; 10,676,580B2; 10,723,838B2, and 10,865,276B2.

The first and second acrylic beads are multistage and crosslinked, with a first stage polymer phase comprising a low Tg (≤20° C. in one embodiment, <10° C. in another embodiment, and <0° C. in still another embodiment, as calculated by the Fox equation) homo- or copolymer that is crosslinked to provide resiliency and no diffusion to the substrate; and a high Tg second stage polymer phase (≥30° C. in one embodiment, >50° C. in another embodiment, as calculated by the Fox equation) to provide beads that are not film-forming at room temperature. At least 50 wt % in one embodiment, at least 70 wt % in another embodiment, and at least 90 wt % in still another embodiment of the crosslinked first stage comprises structural units of (I) butyl acrylate or ethyl acrylate or a combination thereof; and (II) a multi-ethylenically unsaturated nonionic monomer, exemplified herein below, at a (I): (II) w/w ratio in the range of from 99.5:0.5 to 85:15 in one embodiment. A methyl methacrylate homopolymer comprises at least 60 wt % in one embodiment, at least 80 wt % in another embodiment, and 100 wt % in still another embodiment of the second stage.

The first stage of the first and the second acrylic beads comprise from 85 wt % to 99.9 wt % structural units of a monoethylenically unsaturated nonionic monomer, examples of which include acrylates such as ethyl acrylate, butyl acrylate, and 2-ethylhexyl acrylate; methacrylates such as methyl methacrylate, n-butyl methacrylate, t-butyl methacrylate, hydroxyethyl methacrylate, hydroxypropyl methacrylate, acetoacetoxyethyl methacrylate, and ureido methacrylate; acrylonitrile; acrylamides such as acrylamide and diacetone acrylamide; styrene; and vinyl esters such as vinyl acetate. Although it is possible for the first stage to include structural units of carboxylic acid monomers such as methacrylic acid or acrylic acid, it is certain embodiments that the first stage comprises <5 wt % in one embodiment, <3 wt % in another embodiment, and <1 wt % in still another embodiment of structural units of a carboxylic acid monomer, based on the weight of the bead. In a preferred embodiment, the first stage comprises structural units of acrylates or methacrylates or combinations of acrylates and methacrylates.

In other embodiments, the first stage of the first and the second acrylic beads further comprises a multi-ethylenically unsaturated nonionic monomer, at a concentration in the range of from 0.1 wt % to 15 wt % in one embodiment, from 1 wt % to 12 wt % in another embodiment, and from 3 wt %, to 10 wt % in still another embodiment, based the weight of first stage monomers. Examples of suitable multi-ethylenically unsaturated nonionic monomers include allyl methacrylate, allyl acrylate, divinyl benzene, trimethylolpropane trimethacrylate, trimethylolpropane triacrylate, butylene glycol (1,3) dimethacrylate, butylene glycol (1,3) diacrylate, ethylene glycol dimethacrylate, ethylene glycol diacrylate, and mixtures thereof.

In other embodiments, a multi-stage acrylic bead comprising a core-shell particle morphology where a first stage is crosslinked core and have a Tg≤20° C. and a second stage is grafted as a shell to the core and have a Tg≥30° C.

The crosslinked particles of the first acrylic dispersion have an average particle size (technically, a median weight average particle size, D₅₀) of ≤4 μm in one embodiment, in the range of from 1 μm to 4 μm in another embodiment, and from 2 μm to 3.5 μm in still another embodiment, as measured using DCP as described herein below.

The crosslinked particles of the second acrylic dispersion have an average particle size (technically, a median weight average particle size, D₅₀) of ≤0.99 μm in one embodiment, in the range of from 0.2 μm to 0.99 μm in another embodiment, and from 0.5 μm to 0.9 μm in still another embodiment, as measured using DCP as described herein below.

In a preferred embodiment, the composition of multistage crosslinked acrylic beads are functionalized with from up to 5 wt %, based on the weight of the beads, of one or more polymerizable organic phosphates or salts thereof. The polymerizable organic phosphate useful in the present invention is represented by the following general chemical Formula (I):

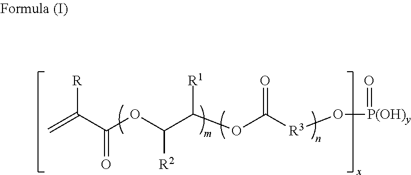

or a salt thereof; wherein R is H or CH₃, wherein R¹ and R² are each independently H or CH₃, with the proviso that no two adjacent CR²CR¹ groups are CH(CH₃)CH(CH₃) groups; each R³ is independently linear or branched C₂-C₆ alkylene; m is from 2 to 10; n is from 0 to 5; x is 1 or 2; and y is 1 or 2; and x+y=3; or n is 1; m is 1; R is CH₃; R¹ and R² are each H; R³ is —(CH₂)₅—; x is 1 or 2; y is 1 or 2; and x+y=3; wherein the polymeric beads have a solids content in the range of from 10 wt % to 60 wt % in one embodiment, and in the range of from 30 wt % to 55 wt % in another embodiment, based on the weight of multi-stage crosslinked acrylic beads and water.

In another preferred embodiment, the composition of multistage crosslinked acrylic beads are functionalized with from 0.2 wt % to 2 wt %, based on the weight of the beads, of an acid or an ammonium salt of the polymerizable organic phosphate represented by either of the following general chemical Formula (II):

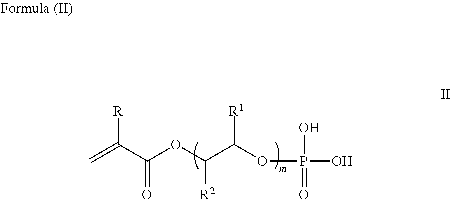

where m is from 4 to 6; and where each CR²CR¹ group is either CH(CH₃)CH₂ or CH₂CH(CH₃). Sipomer PAM-100 (acid form), Sipomer PAM-200 (acid form) and Sipomer PAM-600 (ammonium salt form) phosphate esters are examples of commercially available compounds of the above-described Formula (II) or the following general chemical Formula (III):

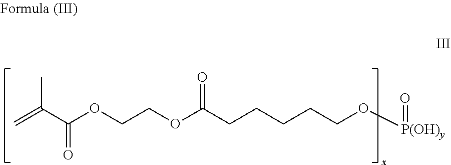

where x is 1 or 2; and y is 1 or 2; and x+y=3. In one preferred embodiment, a commercially available compound within the scope of Formula (III) is Kayamer PM-21 phosphate ester.

The multi-stage crosslinked particles of the first acrylic bead dispersion have an average surface Young's modulus ≥450 MPa in one embodiment, and ≥500 MPa in another embodiment, as measured using Atomic Force Microscopy at 2,000 Hertz (Hz) as described herein below.

The loading level based on solid of the first acrylic dispersion is ≤70 dry wt % in one general embodiment; from ≥30 dry wt % to ≤70 dry wt % in another embodiment; and from 40 dry wt % to 60 wt % in still another embodiment, based on the dry weight of the formulation.

The loading level based on solid of the second acrylic dispersion is ≤40 dry wt % in one general embodiment; from ≥10 wt % to ≤40 wt % in another embodiment; from 15 dry wt % to 35 dry wt % in still another embodiment; and from 20 dry wt % to 30 dry wt % in yet another embodiment based on dry weight of the formulation.

The third acrylic emulsion, component (Aiii), which is different from the first acrylic dispersion and the second acrylic dispersion and which is used as a binder, has a Tg of from −30° C. to 60° C. For example, the Tg of the binder particles is ≤60° C. in a general embodiment; from −30° C. to 30° C. in another embodiment; from −20° C. to 20° C.; in still another embodiment; and from −10° C. to 15° C. in yet another embodiment.

The third emulsion used as a binder, component (Aiii), includes for example, acrylic emulsions are preferably acrylic based, meaning these binder particles comprise at least 30 weight percent, based on the weight of the binder particles, of structural units of one or more methacrylate monomers such as methyl methacrylate and ethyl methacrylate, and/or one or more acrylate monomers such as ethyl acrylate, butyl acrylate, 2-propylheptyl acrylate, and 2-ethylhexyl acrylate. The acrylic-based binders may also include structural units of ethylenically unsaturated acid monomers such as methacrylic acid, acrylic acid, and itaconic acid, or salts thereof, as well as other non-acrylate or methacrylate monomers such as styrene, acrylonitrile, and vinyl acetate.

In another embodiment, hydrophobic acrylic binders may also be used in the coating formulation to further lower the COF of the matte finish. Hydrophobic acrylic binders are defined as binders comprising of at least 30 wt % hydrophobic acrylate or methacrylate esters of tert-butyl alcohol, 2-ethylhexyl alcohol, cyclohexyl alcohol, isobornyl alcohol, lauryl alcohol, and other long chain linear or branched alcohols; and mixtures thereof.

In another embodiment the third particles used as a binder, component (Aiii), includes for example, polyurethane dispersions, polyvinyl acetate emulsions, styrene-acrylic emulsions, and mixtures thereof.

The particles of the third acrylic emulsion have a z-average particle size of ≤0.3 μm in in diameter in one general embodiment; from ≥0.05 μm to ≤0.3 μm in diameter in another embodiment; from 0.05 μm to 0.25 μm in still another embodiment; and from 0.05 μm to 0.2 μm in yet another embodiment.

In some embodiments, the third binder emulsion useful in the present invention can be selected from commercially available third acrylic binder emulsion products. For example, the third acrylic binder emulsion can be Opulux™ 1000 (available from Dow Inc.); and Rhobarr™ 110 (available from Dow Inc.); Bayderm™ polyurethane dispersions (available from Lanxess, Leverkusen); and mixtures thereof.

The loading level based on solid of the third acrylic binder dispersion is ≤30 dry wt % in one general embodiment; from ≥10 dry wt % to ≤30 dry wt % in diameter in another embodiment; from 13 dry wt % to 28 dry wt % in still another embodiment; and from 17 wt % to 25 wt % in yet another embodiment based on the dry weight of the formulation.

The rheology modifier, component (B) useful in the present invention can include at least one rheology modifier or a combination of two or more different rheology modifiers at a total loading level up to 2.0 dry wt % wherein the loading is based on the total dry weight of the formulation. Exemplary of the rheology modifier used in the present invention is a combination, blend or mixture of more than one rheology modifier; and in a preferred embodiment, the rheology modifier, component (B) is a combination of at least two rheology modifiers such as (Bi) a first rheology modifier; and (Bii) a second rheology modifier. In certain embodiments, the rheology modifier includes, for example, an alkali swellable emulsion (“ASE”) type polymer, a hydrophobically-modified alkali swellable emulsion (“HASE”) type polymer, hydrophobically modified ethoxylate urethane (HEUR) type, and mixtures thereof.

For example, the first rheology modifier, component (Bi), includes a HEUR type rheology modifier in water solution.

In some embodiments, the first rheology modifier useful in the present invention can be selected from commercially available rheology modifier products. For example, the first rheology modifier can be Acrysol™ RM-2020E (available from Dow Inc.); and Acrysol™ RM-8W (available from Dow Inc); and mixtures thereof.

The loading level of the first rheology modifier is generally up to 2.0 dry wt % in one embodiment; from 0.1 dry wt % to 1.5 dry wt % in another embodiment; and from 0.3 dry wt % to 1.0 dry wt % in still another embodiment, wherein the loading is based on the dry weight of the formulation.

The second rheology modifier, component (Bii), which is different than the first rheology modifier, includes for example, a polyacrylic or polymethacrylic acid rheology modifier such as an ASE type polymer in water solution.

In some embodiments, the second rheology modifier useful in the present invention can be selected from commercially available rheology modifier products. For example, the second rheology modifier can be Acrysol™ ASE-60 (available from Dow Inc); Acrysol™ ASE-75 (available from Dow Inc); and mixtures thereof.

The loading level of the second rheology modifier is generally up to 2.0 dry wt % in one embodiment; from 0.05 dry wt % to 1.5 dry wt % in another embodiment; and from 0.1 dry wt % to 1.0 dry wt % in still another embodiment, wherein the loading is based on the dry weight of the formulation.

The defoamer, component (C), useful in the present invention can include at least one defoamer or a combination of two or more different defoamers at a total loading level up to 0.5 dry wt % wherein the loading is based on the total dry weight of the formulation. Exemplary of the defoamer is a combination, blend or mixture of more than one defoamer; and in one preferred embodiment, the defoamer, component (C), is a combination of at least two defoamer components such as a first defoamer; and a second defoamer.

For example, the defoamer, component (C), can be selected from one or more of the following products: Tego Antifoam 4-94 (available from Evonik); Tego Antifoam 2291 (available from Evonik); TegoAntifoam 4-88 (available from Evonik); and mixtures thereof.

The total loading level of the defoamers is generally up to 0.5 dry wt % in one embodiment; from 0.1 dry wt % to 0.3 dry wt % in another embodiment; and from 0.15 dry wt % to 0.25 dry wt % in still another embodiment, wherein the loading is based on total dry weight of the formulation.

The neutralization agent, component (D), useful in the present invention can include one or more neutralization agents. Exemplary of the at least one neutralization agent, component (D), useful in the present invention includes ammonia, triethylamine (TEA), other amines, sodium hydroxide, potassium hydroxide, and mixtures thereof.

In some embodiments, the neutralization agent useful in the present invention can be selected from commercially available neutralization agent products. For example, the neutralization agent can be ammonia (28 percent [%] concentration; available from Fisher); and TEA (available from Sigma-Aldrich); and mixtures thereof.

The neutralization agent used in the matte coating formulation is used to adjust the pH of the formulation to a level of from 7.5 to 9.0 in one embodiment; from 7.8 to 8.8 in another embodiment; and from 8.0 to 8.5 in still another embodiment. The pH of the coating formulation is measured using conventional methods and instrumentation, for example, a Digital pH meter according to ASTM E70-19.

The wetting additive, component (E) useful in the present invention, can include at least one wetting additive or a combination of two or more different wetting additives at a total loading level up to 1.0 dry wt % wherein the loading is based on the total dry weight of the formulation. Exemplary of the wetting additive is a combination, blend or mixture of more than one wetting additive; and in a preferred embodiment, the wetting additive, component (E) is a combination of at least two wetting additive components such as a first wetting additive and a second wetting additive.

For example, the wetting additives, component (E), can be selected from one or more of the following products: Triton GR-5M (available from Dow Inc.); Polystep B-5 (available from Stepan); and mixtures thereof.

The total loading level of the wetting additives is generally up to 1.0 dry wt % in one embodiment; from 0.1 dry wt % to 0.8 dry wt % in another embodiment; and from 0.2 dry wt % to 0.6 dry wt % in still another embodiment, wherein the loading is based on the dry weight of the formulation.

The slip additive, component (F) useful in the present invention can include at least one slip additive or a combination of two or more slip additives at a total loading level of up to 7.0 dry wt % based on the total dry weight of the formulation. Exemplary of the slip additive is a combination, blend or mixture of more than one slip additives; and in a preferred embodiment, the slip additive, component (F) is a combination of at least two slip additive components such as (Fi) a first slip additive; and (Fii) a second slip additive.

For example, the first slip additive, component (Fi), useful in the present invention can be selected from commercially available slip additives based on silicone dispersions. For example, the first slip additive can be TE-352 FG (available from ICM); Dowsil™ DC-51, Dowsil™ DC-52, Dowsil™ 401, and Dowsil™ 27 (all available from Dow Inc.); and mixtures thereof.

The loading level of the first slip additive is generally up to 7.0 dry wt % in one embodiment; from 0.5 dry wt % to 5.0 dry wt % in another embodiment; and from 1.0 wt % to 3.0 wt % in still another embodiment, wherein the loading is based on the dry weight of the formulation.

For example, the second slip additive, component (Fii), useful in the present invention can be selected from commercially available slip additives based on wax dispersions. For example, the second slip additive can be Acrawax C (available from Lonza Company); Hydrocer 145 (available from Shamrock); and mixtures thereof.

The loading level of the second slip additive is generally up to 7.0 dry wt % in one embodiment; from 1 dry wt % to 6 dry wt % in another embodiment; and from 2 dry wt % to 5 dry wt % in still another embodiment, wherein the loading is based on the dry weight of the formulation.

The water-dispersible polyisocyanate, component (G), useful in the present invention as a post-crosslinker, can include one or more water-dispersible polyisocyanates. Exemplary of the at least one water dispersible polyisocyanate, component (G), used as a crosslinker in the present invention includes water-dispersible aliphatic diisocyanates such as various forms of hexamethylene di-isocyanate (HDI), methylene dicyclohexyl diisocyanate also called hydrogenated MDI (HMDI), isophorone diisocyanate (IPDI), and mixtures thereof.

In some embodiments, the water-dispersible polyisocyanate useful in the present invention can be selected from commercially available water-dispersible polyisocyanate products. For example, the water-dispersible polyisocyanate can be CR 9-101 (available from Dow Inc.); Bayhydur® Ultra 2487/1, Bayhydur® Ultra 304, and Bayhydur® Ultra 3100 (all available from Covestro); and mixtures thereof.

The loading level of the at least one water-dispersible post-crosslinker is generally up to 10 dry wt % in one embodiment; from 1.0 dry wt % to 9.0 dry wt % in another embodiment; and from 2.0 dry wt % to 8.0 dry wt % in still another embodiment, wherein the loading is based on the dry weight of the formulation.

As an optional component (H), water may be added to the coating composition for dilution such as to reduce the total solids of the coating composition to a desired range. The water, can be sourced from any water source. The water can include, for example, deionized water. In addition, water may be added to one or more of the other components (A)-(G) to form an aqueous composition such that the components can be shipped in a stable concentrated form.

Optionally, the coating composition of the present invention may be formulated with a wide variety of additives to enable performance of specific functions while maintaining the excellent benefits/properties of the present invention composition. For example, optional components useful in the coating formulation of the present invention may be selected from anti-static additives, blocking additives, and mixtures thereof.

The optional compounds, when used in the coating composition of the present invention, can be present in an amount generally up to 2 dry wt % in one embodiment; from 0.1 dry wt % to 1.0 dry wt % in another embodiment; and from 0.2 dry wt % to 0.8 dry wt % in still another embodiment, wherein the loading is based on the dry weight of the formulation.

In one broad embodiment, the process for making the matte coating formulation of the present invention includes mixing, admixing, combining or blending the above-described components (A)-(G) to form the matte coating formulation. One or more additional optional components, such as water, optional component (H), may be added to the matte coating formulation as desired. For example, the components (A)-(G) can be mixed together in the desired concentrations discussed above and at a temperature of from 10° C. to 50° C. in one embodiment; and from 20° C. to 30° C. in another embodiment. The order of mixing of the components (A)-(F) is not critical and two or more of these components can be mixed together followed by addition of the remaining components such as the crosslinker, component (G). The matte coating formulation components may be mixed together by any known mixing process and equipment such as an overhead mixer; or a Flacktek speed mixer.

The matte coating formulation of the present invention produced by the process described above has several advantageous properties and benefits. For example, some of the properties/benefits exhibited by the present invention formulation can include, for example, high solids content, low foaming, high shelf stability at 45° C. and at 3° C., and an appropriate application processing rheology property.

The viscosity of the coating formulated products, before incorporating a post-crosslinker into the formulation, is measured using conventional methods and instrumentation, for example a Brookfield Viscometer. For example, the viscosity of the coating composition of the present invention, can be generally in the range of from 200 millipascals-seconds (mPa-s) to 700 mPa-s in one embodiment; from 300 mPa-s to 600 mPa-s in another embodiment; and from 450 mPa-s to 500 mPa-s in still another embodiment.

The solids content of the coating formulation is measured using conventional methods and instrumentation. For example, the solids content of the coating composition of the present invention, can be generally in the range of from 32 wt % to 55 wt % in one embodiment; from 34 wt % to 50 wt % in another embodiment; and from 36 wt % to 45 wt % in still another embodiment.

The foaming generated by the coating formulation of the present invention should be less as possible to obtain the best performance of the formulation. The foaming generated by the formulation is generally in the range of from 0% to 50% in one embodiment; from 0.001% to 40% in another embodiment; and from 0.01% to 30% in still another embodiment.

The shelf stability of the coating formulation of the present invention is measured at a temperature of 45° C. for a time period of 1 month; and a temperature of 3° C. for a time period of 1 month. Shelf stability for the coating formulation is determined by visual observation of the formulation to see whether or not the coating formulation undergoes phase separation during that time period. After exposing the coating formulation of the present invention to 45° C. for 1 month, the coating formulation of the present invention does not undergo phase separation as determined visually with the naked eye.

The film substrate used for making the matte coated film substrate of the present invention, in general, is a polyolefin film web and can include one or more polyolefins. For example, the film substrate can include one or more polyolefin layers such as high density polyethylene (HDPE), low density polyethylene (LDPE), linear low density polyethylene (LLDPE), medium density polyethylene (MDPE), and mixtures thereof.

In some embodiments, the polyolefin film coated with the coating formulation of the present invention can include oriented single or multilayer PE films made using either machine direction or biaxial orientation processes which is bonded to a second layer film substrate. For example, the oriented polyolefin film useful in the present invention can be oriented polyethylene (OPE), biaxially oriented polyethylene (BOPE), and mixtures thereof.

In other embodiments, the polyolefin film can be a polypropylene (PP) film or a biaxially oriented PP (BOPP) film.

In still other embodiments, the film substrate coated with the coating formulation of the present invention can be a multilayer film structure comprising two or more layers. For example, the multilayer polyolefin film can be a film comprised two or more layers of HDPE, LLDPE, and LDPE.

In some embodiments, the film substrate can include, for example, a laminate film structure comprising a first PE film selected from HDPE, LLDPE and LDPE which is bonded to a second PE film different from the first PE film and selected from HDPE, LLDPE and LDPE. The multilayer films can be bonded together using any conventional adhesive.

In other embodiments, the film substrate can include, for example, PET, Nylon, PLA, and combinations thereof.

The thickness of the polyolefin film used to form the coated substrate of the present invention can be, for example, from 10 μm to 300 μm in one embodiment, from 10 μm to 200 μm in another embodiment and from 10 μm to 100 μm in still another embodiment.

In general, the coated substrate of the present invention is produced by applying the above-described aqueous matte coating composition of the present invention to a film substrate and drying the coating on the substrate. In a preferred embodiment, the process includes the steps of:
(I) forming the aqueous matte coating composition, comprising:
   (a) at least one acrylic bead having an average particle diameter of ≤4 μm size and with surface Young's modulus of ≥450 MPa.
   (b) at least one polymer binder; and
   (c) at least one slip additive comprising a silicone or a wax dispersion;
(II) applying the aqueous matte coating composition of step (I) to at least a portion of the surface of one or more film substrates to form a coating layer on the substrate; and
(III) drying, or allowing to dry, (or optionally curing) the applied aqueous matte coating composition on the substrate.

The forming step (I) of the present invention process, for forming the aqueous matte coating composition, is described above including combining components (A)-(G) and optionally component (H).

One of the advantages of the present invention process is that the application step (II) of the present invention process can be carried out by several conventional processes and equipment known in the art such by gravure, Flexographic printing, and offset printing processes.

In other embodiments, the applying step (II) of the present invention process, for coating (applying) the matte coating compositions to substrates may be carried out by any known method such as spray, brush, roll, electrostatic bell or fluid bed methods. For example, the coating composition may be applied to the substrates: (1) by a curtain coater; (2) by spraying methods such as air-atomized spray, air-assisted spray, airless spray, high volume, low pressure spray, and air-assisted airless spray; (3) by roll coating; and (4) by knife coating.

The drying step (III) of the present invention process may be performed in a known manner for coating substrates. For example, the drying step (III) can be carried out by air drying or heat drying at temperatures that will not damage the substrate. For example, the oven temperature of drying of step (III) can be ≤150° C. in one embodiment, ≤100° C. in another embodiment; from 80° C. to 150° C. in still another embodiment, and from 90° C. to 100° C. in yet another embodiment. In another embodiments, after coating the film substrate, the coated films are continually cured at room temperature for 7 days before the coated film material is used in packaging applications.

If desired, alternative methods for applying the coating formulation on the film substrate to make the matte coated substrate can include, for example, hand drawdown, spray, brushing, or roller coater; and the like.

When the coating is applied to the film substrate, the coating weight is generally from 0.8 gram per meter squared (g/m²) to 5 g/m² in one embodiment; from 1.0 g/m² to 4.0 g/m² in another embodiment; and from 1.6 g/m² to 3.2 g/m² in still another embodiment.

The matte coating layer of the present invention formed on a film substrate produced by the process described above has several advantageous properties and benefits. For example, some of the properties/benefits exhibited by the present invention matte finish coated film can include, for example, low COF, increased color fidelity, low gloss, strong abrasion resistance, strong adhesion, and excellent soft touch.

The low gloss at 60° of the coated substrates of the present invention, is generally in the range of from 1 gloss unit to 20 gloss units in one embodiment; from 4 gloss units to 10 gloss units in another embodiment; and from 5 gloss units to 10 gloss units in still another embodiment.

The low gloss at 85° of the coated substrates of the present invention, is generally in the range of from 1 gloss unit to 40 gloss units in one embodiment; from 5 gloss units to 35 gloss units in another embodiment; and from 10 gloss units to 30 gloss units in still another embodiment. The gloss of the coated substrate formulation is measured using conventional methods and instrumentation, for example, the gloss property of coated films can be analyzed at 60° and at 85° using a BYK Gardner Glossmeter (micro-tri-gloss).

The abrasion resistance of the coated substrate of the present invention is measured using conventional methods and instrumentation, for example, the abrasion resistance is determined using a Sutherland Ink Rub Tester to provide a number of Sutherland Rub cycles based on 100 cycles/read. The test is carried out with a 1.8 kilograms (kg) weight loading with 1 rub cycle/sec running speed. The coated films are allowed to cure at room temperature (23° C.) for 1 week before conducting the above abrasion resistance test. The abrasion resistance of the coated substrate of the present invention, is generally in the range of from 500 number of Sutherland Rub cycles to 5,000 number of Sutherland Rub cycles in one embodiment; from 700 number of Sutherland Rub cycles to 4,000 number of Sutherland Rub cycles in another embodiment; and from 1,000 number of Sutherland Rub cycles to 3,000 number of Sutherland Rub cycles in still another embodiment.

The coating-to-coating (C—C)/Static COF of the coated substrate of the present invention, is generally in the range of from 0.1 to 2.0 in one embodiment; from 0.2 to 1.5 in another embodiment; and from 0.3 to 1.0 in still another embodiment. The COF of the coated substrate is measured using conventional methods and instrumentation, for example, the COF of the coated films is determined using a TMI Friction and Slip Tester Model 32-07-00 at 25° C. and 50% relative humidity (RH).

The soft touch of the coated substrate of the present invention, is generally in the range of from 1 to 5 in one embodiment; from 3 to 5 in another embodiment; and from 4 to 5 in still another embodiment. The soft touch property of the coated substrate is determined by conventional means, for example, a comparison of soft touch for various coated film substrates is conducted by human sensory panels in a sensory laboratory. Soft touch is determined by detecting the differences in hand feel perception when different coated substrates or laminated structures are compared.

The heat seal resistance of the coated substrate of the present invention, is generally in the range of from 120° C. to 205° C. in one embodiment; from 130° C. to 202° C. in another embodiment; and from 140° C. to 202° C. in still another embodiment. The heat seal resistance of the coated substrate is measured using conventional methods and instrumentation. For example, the heat seal resistance of the coated films is evaluated by the V-Fold Heat Resistance Test with a heat sealer at a temperature of 205° C., a pressure of 276 kPa, and a duration time of 1 s. After the films are heat sealed, the coated films are designated as “pass” or “fail”. A coated film substrate “passed” if no adhesion or no finish is removed from the coating; or no gloss of the coating is changed. A coated film substrate “failed” if the films undesirably stacked together or the matte finish peeled off the coated film substrate; or the gloss of the coating changed.

The adhesion strength of the coated films can be measured using conventional methods and instrumentation such as a tape adhesion test. The tape adhesion test is conducted using, for example, 3M Scotch 610 tape. In the test, the tape is applied, with finger pressure, on the matte coating and after a few seconds, the tape is pulled (peeled) off from the coating quickly. Then, the amount of coating peeled off with the tape, if any, is measured. A rating system of numbers 1 to 5 is used to assess the adhesion property of the coated substrate by visually observing the amount of coating peeled off of the coated substrate. A rating of “1” means the amount of coating peeled off of the coated substrate with the tape is ≥90%; a rating of “2” means the amount of coating peeled off of the coated substrate with the tape is ≤60%; a rating of “3” means the amount of coating peeled off of the coated substrate with the tape is ≤20%; a rating of “4” means the amount of coating peeled off of the coated substrate with the tape is ≤10%; and a rating of “5” means the amount of coating peeled off of the coated substrate with the tape is essentially none or zero, i.e., no coating is peeled off the coated substrate with the tape.

In other embodiments, the adhesion strength of the coated substrate of the present invention, is measured by the procedure as described in ASTM standard D3359 except that crosshatching is not used in the adhesion test (i.e., no cuts are made on the film being tested). For example, the adhesion strength of the coated substrate is in the range of from 3 to >5 in one general embodiment; from 3 to 5 in another embodiment; and from 4 to 5 in still another embodiment.

In one general embodiment, the coated film substrate of the present invention is used in packaging applications for manufacturing various packaging materials and products. For example, the matte coating substrate can be used for food packaging, for cosmetic packaging, and for electronic packaging. Other applications include non-food packaging applications such as agricultural chemical packaging.

### Examples

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of compositions described herein. Unless otherwise stated all parts and percentages are by weight on a total weight basis.

In the Examples, the following abbreviations have the meanings given:
DI=deionized; PET=polyethylene terephthalate; OPP=oriented PP; and HDPE=high density polyethylene.

Various materials used in the Inv. Ex. and the Comp. Ex., which follow, are described in Table I.

TABLE I
Raw Materials

| Material | Brief Description | Supplier |
|---|---|---|
| Bead1 | The first acrylic bead dispersion with 3 μm particle size | Dow Inc. |
| | with >450 megapascal surface Young's modulus. 43.0% | |
| | solids content. | |
| Bead2 | The second acrylic bead dispersion with 0.85 μm particle | Dow Inc. |
| | size, 32.0% solids content. | |
| Bead3 | The third acrylic bead dispersion with 5 μm particle size, | Dow Inc. |
| | 32.0% solids content. | |
| Bead4 | The fourth acrylic bead dispersion with 3 μm particle size | Dow Inc. |
| | with <450 megapascal surface Young's modulus, 43.0% | |
| | solids content. | |
| Binder1 | An acrylic binder No. 1, 34.5% solids content. | Dow Inc. |
| Binder2 (RHOBARR ™ 110) | An acrylic binder No. 2, 49.0% solids content. | Dow Inc. |
| ASE-type Rheology modifier | An alkali swellable emulsion (ASE) type rheology | Dow Inc. |
| | modifier additive, 28.0% solids content. | |
| Aqueous Ammonia (28%) | A neutralization agent. | Fisher |
| POLYSTEP B-5 | A wetting additive, 29.0% solids content. | Stepan |
| TRITON GR-5M | A wetting additive, 60.0% solids content. | Dow Inc. |
| ACRYSOL RM-2020E | A hydrophobically modified ethoxylate urethane (HEUR) | Dow Inc. |
| | based rheology modifier, 20.0% solids content. | |
| ACRAWAX C dispersion | A slip additive, a dispersion form of synthetic wax, | Lonza |
| | 33.0% solids content. | |
| A wax dispersion | A slip additive, a dispersion form of synthetic wax, | Shamrock |
| | 40.0% solids content. | |
| HYDROCER 145 | A slip additive, a dispersion of a synthetic wax, 50.0% | Shamrock |
| | solids content. | |
| TE-352 FG | A slip additive; a silicon emulsion, 40.0% solids content. | ICM |
| TEGO ANTIFOAM 4-94 | A defoamer additive; an organo-modified siloxanes | Evonik |
| | emulsion, 40.0% solids content. | |
| TEGO FOAMEX 1488 | A defoamer additive, a polyether siloxane based | Evonik |
| | emulsion, 20.0% solids content. | |
| CR 9-101 | A modified aliphatic isocyanate; a post-crosslinker added | Dow Inc. |
| | just before the coating is applied, 100% solids content. | |
| DI water | A diluent | Dow Inc. |
| PET film | A film 12 μm thick | Filmquest |
| OPP film | A film 20 μm thick | Mult Filmse |
| HDPE film | A film 50 μm thick | Dow Inc. |
| Nylon film | A film 15 μm thick | Advan Six |

### Examples 1-4 and Comparative Examples A-C

### General Procedure for Preparing Coating Formulation

The raw materials described in Table I above were used to prepare the coating formulations of Inv. Ex. 1-4 described in the following Tables II-V, respectively; and Comp. Ex. A-D described in the following Tables VI-IX, respectively:

TABLE II
Formulation of Inv. Ex. 1

| | Composition | Composition |
|---|---|---|
| Material | (Wet weight %) | (Dry weight %) |
| Bead1 | 43.5% | 50.1% |
| Bead2 | 28.4% | 24.4% |
| Binder1 | 21.3% | 19.7% |
| TEGO ANTIFOAM 4-94 | 0.2% | 0.2% |
| Aqueous Ammonia | 0.1% | 0.0% |
| ASE-type rheology modifier | 0.2% | 0.2% |
| ACRYSOL RM-2020E | 1.2% | 0.6% |
| TRITON GR-5M | 0.1% | 0.1% |
| TE-352 FG | 1.3% | 1.4% |
| ACRAWAX C DISPERSION | 3.3% | 3.0% |
| POLYSTEP B-5 | 0.3% | 0.3% |
| TEGO FOAMEX 1488 | 0.1% | 0.03% |
| TOTAL | 100.0% | 100.0% |

TABLE III
Formulation of Inv. Ex. 2

| | Composition | Composition |
|---|---|---|
| Material | (Wet weight %) | (Dry weight %) |
| Bead1 | 41.8% | 50.1% |
| Bead2 | 27.3% | 24.4% |
| Binder1 | 20.5% | 19.7% |
| TEGO ANTIFOAM 4-94 | 0.2% | 0.2% |
| Aqueous Ammonia | 0.1% | 0.0% |
| ASE-type rheology modifier | 0.2% | 0.2% |
| DI Water | 3.9% | 0.0% |
| ACRYSOL RM-2020E | 1.1% | 0.6% |
| TRITON GR-5M | 0.1% | 0.1% |
| TE-352 FG | 1.3% | 1.4% |
| ACRAWAX C DISPERSION | 3.2% | 3.0% |
| POLYSTEP B-5 | 0.3% | 0.3% |
| TEGO FOAMEX 1488 | 0.1% | 0.03% |
| TOTAL | 100.0% | 100.0% |

TABLE IV
Formulation of Inv. Ex. 3

| | Composition | Composition |
|---|---|---|
| Material | (Wet weight %) | (Dry weight %) |
| Bead1 | 41.8% | 50.4% |
| Bead2 | 27.3% | 24.5% |
| Binder2 | 13.9% | 19.1% |
| TEGO ANTIFOAM 4-94 | 0.2% | 0.2% |
| ACRYSOL RM-2020E | 1.1% | 0.6% |
| TRITON GR-5M | 0.1% | 0.1% |
| DI water | 11.0% | 0.0% |
| TE-352 FG | 1.3% | 1.4% |
| Amide wax dispersion | 2.7% | 3.1% |
| ASE-type rheology modifier | 0.2% | 0.2% |
| POLYSTEP B-5 | 0.5% | 0.4% |
| TOTAL | 100.0% | 100.0% |

TABLE V
Formulation of Inv. Ex. 4

| | Composition | Composition |
|---|---|---|
| Material | (Wet weight %) | (Dry weight %) |
| Bead1 | 41.8% | 50.0% |
| Bead2 | 27.3% | 24.3% |
| Binder1 | 20.5% | 19.7% |
| TEGO ANTIFOAM 4-94 | 0.2% | 0.2% |
| ACRYSOL RM-2020E | 1.1% | 0.6% |
| TRITON GR-5M | 0.1% | 0.1% |
| DI water | 4.4% | 0.0% |
| TE-352 FG | 1.3% | 1.4% |
| Amide wax dispersion | 2.7% | 3.0% |
| ASE-type rheology modifier | 0.2% | 0.2% |
| POLYSTEP B-5 | 0.5% | 0.4% |
| TOTAL | 100.0% | 100.0% |

TABLE VI
Formulation of Comp. Ex. A

| | Composition | Composition |
|---|---|---|
| Material | (Wet weight %) | (Dry weight %) |
| Bead4 | 41.8% | 50.0% |
| Bead2 | 27.3% | 24.3% |
| Binder1 | 20.5% | 19.7% |
| TEGO ANTIFOAM 4-94 | 0.2% | 0.2% |
| ACRYSOL RM-2020E | 1.1% | 0.6% |
| TRITON GR-5M | 0.1% | 0.1% |
| DI water | 4.4% | 0.0% |
| TE-352 FG | 1.3% | 1.4% |
| Amide wax dispersion | 2.7% | 3.0% |
| ASE-type rheology modifier | 0.2% | 0.2% |
| POLYSTEP B-5 | 0.5% | 0.4% |
| TOTAL | 100.0% | 100.0% |

TABLE VII
Formulation of Comp. Ex. B

| | Composition | Composition |
|---|---|---|
| Material | (Wet weight %) | (Dry weight %) |
| Bead3 | 51.2% | 50.1% |
| Bead2 | 25.3% | 24.7% |
| Binder1 | 18.6% | 19.6% |
| TEGO ANTIFOAM 2291 | 0.2% | 0.6% |
| Ammonia hydroxide | 0.1% | 0.0% |
| ACRYSOL RM-2020E | 1.2% | 0.7% |
| TRITON GR-5M | 0.1% | 0.1% |
| DI water | 0.3% | 0.0% |
| TE-352 FG | 1.2% | 1.4% |
| HYDROCER 145 | 1.9% | 2.8% |
| TOTAL | 100.0% | 100.0% |

TABLE VIII
Formulation of Comp. Ex. C

| | Composition | Composition |
|---|---|---|
| Material | (Wet weight %) | (Dry weight %) |
| Bead3 | 51.2% | 50.1% |
| Bead2 | 25.2% | 24.7% |
| Binder1 | 18.6% | 19.6% |
| TEGO ANTIFOAM 4-94 | 0.2% | 0.2% |
| Aqueous Ammonia | 0.0% | 0.0% |
| ASE-type rheology modifier | 0.3% | 0.2% |
| DI Water | 0.2% | 0.0% |
| ACRYSOL RM-2020E | 1.3% | 0.8% |
| TRITON GR-5M | 0.1% | 0.1% |
| TE-352 FG | 1.2% | 1.4% |
| HYDROCER 145 | 1.9% | 2.8% |
| TOTAL | 100.0% | 100.0% |

TABLE IX
Formulation of Comp. Ex. D

| | Composition | Composition |
|---|---|---|
| Material | (Wet weight %) | (Dry weight %) |
| Bead3 | 28.4% | 27.6% |
| Bead2 | 26.7% | 25.9% |
| Binder1 | 43.3% | 45.4% |
| TEGO ANTIFOAM 2291 | 0.2% | 0.6% |
| Aqueous Ammonia | 0.1% | 0.0% |
| ASE-type rheology modifier | 0.6% | 0.5% |
| DI water | 0.6% | 0.0% |
| TOTAL | 100.0% | 100.0% |

### General Procedure for Preparing Components of the Coating Formulation

### Synthesis of Bead1

Bead1, used in the present Examples, is produced in accordance with the procedure described in Example 6, column 10, lines 30-44 of U.S. Pat. No. 10,676,580 except with the following modifications: (1) the final solids content of the coating formulation is adjusted to 43%; (2) allyl methacrylate in shot ME and ME1 are both increased with additional 50% while n-butyl acrylate in shot ME and ME1 were reduced by the same amount of additional allyl methacrylate added in shot ME and ME1; (3) the amount of acrylic oligomer seed is increased to make 3.0 μm weight median particle size and the particle size is measured using DCP as described in column 7, lines 34-44 of U.S. Pat. No. 10,676,580.

### Synthesis of Bead2

A two-stage acrylic bead, Bead2, having a particle size of 0.85 μm in average diameter is produced using the procedure described in Sample D, column 14, lines1-48 of U.S. Pat. No. 9,410,053 B2.

### Synthesis of Bead3

A two-stage acrylic bead, Bead3, having a particle size of 6 μm in average diameter is produced using the procedure described in Example 2, column 18, lines 50-65 to column 19, lines 1-20 of U.S. Pat. No. 7,829,626.

### Synthesis of Bead4

Bead4, used in the present Examples, is produced in accordance with the procedure described in Example 6, column 10, lines 30-44 of U.S. Pat. No. 10,676,580 except with the following modifications: (1) the final solids content of the coating formulation is adjusted to 43%; (2) the amount of acrylic oligomer seed is adjusted to make 3.0 μm weight median particle size and the particle size is measured using DCP as described in column 7, lines 34-44 of U.S. Pat. No. 10,676,580.

### Synthesis of Binder1

A two-stage acrylic binder, Binder1, is produced using the procedure described in Example 9, column 21, lines 1-10 of U.S. Pat. No. 7,829,626.

### General Procedure for Preparing Coating Formulation

In general, a matte coating formulation, for the Inv. Ex. and Comp. Ex., is prepared as follows: acrylic beads material is loaded into a vessel equipped with a mixing impeller. Then, a defoamer is added to the acrylic beads material in the vessel followed by adding an acrylic binder under mixing of the contents of the vessel. A rheology modifier and other additives are added to the vessel under mixing. After mixing for a period of time of from 10 min to 20 min (which may depend on scale size), the resultant mixture is neutralized with ammonia to provide a coating material with a pH of from 7.5 to 9.0.

After preparing the coating material as described above and before applying the coating material to a film substrate, 0.5-1.0 parts of water dispersible polyisocyanate per hundred parts of wet material (1.4-2.8 dry wt % polyisocyanate based on the dry weight of the coating formulation) is added into the formulated coating material sample under mixing; and mixing is continued for 20 min before application of the coating material to a substrate.

### Property Measurements of Matte Coating Formulation

Some of the physical properties of the matte coating formulation were measured; and the results of such measurements are described in Table X.

TABLE X
Properties of Matte Coating Formulations

| | Inv. Ex. | Inv. Ex. | Inv. Ex. | Inv. Ex. | Comp. | Comp. | Comp. | Comp. |
|---|---|---|---|---|---|---|---|---|
| Property | 1 | 2 | 3 | 4 | Ex. A | Ex. B | Ex. C | Ex. D |
| Ratio of wet matte | 100/0.75 | 100/0.75 | 100/1.0 | 100/1.0 | 100/1.0 | 100/1.0 | 100/1.0 | 100/1.0 |
| coating/post- | | | | | | | | |
| crosslinker: | | | | | | | | |
| Solid content (%): | 38 | 36 | 36 | 36 | 36 | 32 | 32 | 33 |
| pH: | 8.34 | 8.28 | 9.02 | 8.06 | 8.27 | 9.0 | 8.5 | 8.0 |
| Brookfield viscosity, | 350 | 224 | 322 | 168 | 134 | 200 | 252 | 265 |
| (mPa · s): | | | | | | | | |
| Density (g/cm³): | 1.03 | 1.02 | 1.04 | 1.02 | 1.02 | 1.01 | 1.01 | 1.01 |
| Foaming (%): | 25 | 34 | 45 | 47 | 45 | 55 | 52 | 61 |
| Shelf stability | No PS* | No PS | PS | No PS | No PS | PS | Slightly | PS |
| (45° C. for 1 month): | | | | | | | PS | |
| Shelf stability | No PS | No PS | PS | No PS | No PS | No PS | No PS | No PS |
| (3° C. for 1 month): | | | | | | | | |

Notes
for Table X: *“PS” means “Phase Separation”.

### General Procedure for Applying Matte Coating Formulation

A gravure process was used to apply matte coating formulations onto film substrates. The matte coatings were applied on different film substrates at 122 m/min running speed by a pilot gravure laminator—Labo Combi and Super Combi (Inv. Ex. 3, and Inv. Ex. 4)

The matte coating was applied with A Super Combi coater at 152 m/min running speed on different film substrates (Inv. Ex. 2, Comp. Ex. A, Comp. Ex. B, and Comp. Ex. C,)

The matte coatings were applied on PET film substrate at 305 m/min running speed by a Flexographic printer Robbie's W&H Miraflex CM in TC customer (Inv. Ex. 1).

### Test Methods and Measurements

### Foaming Test

The foaming of the coating formulation is measured using a method including the steps as follows:

Step (1): Weigh out 300 grams (g) of the sample and place it into a 4.7 liters (L) stainless steel bowl and provide a mixer such as a Kitchen Aid Stand Mixer model RRK5A to be used for mixing the contents of the bowl.

Step (2): After making sure the speed control of the mixer is off, place bowl lift handle in down position. Fit bowl supports over locating pins, press down on back of bowl until bowl pin snaps into spring latch, then raise bowl before mixing the contents of the bowl.

Step (3): Attach stainless steel wire whip by slipping onto beater shaft and pressing upward as far as possible. Turn beater to right, hooking the beater over the pin on the shaft.

Step (4): Gradually move the speed control lever of the mixer to a setting of #6; and mix the bowl contents for 5 minutes (min)+10 seconds(s).

Step (5): Turn the mixer off; remove the bowl from the mixer; and immediately pour the mixture sample from the bowl into a clean weight per gallon cup (100 milliliters [mL] size). Measure and record the density of the sample mixture.

Step (6): Using the following general Equation (I), calculate the % foam generated:

$$[ ( weight before mixing - weight after mixing ) / ( weight before mixing ) ] \times 100 = \% Foam \qquad Equation ( I )$$

### Viscosity

The viscosity of the formulated products (before incorporating a crosslinker into the formulation) was measured using a Brookfield Viscometer DV I⁺ spindle #2 at 23° C.

### Gloss

The gloss property of coated PET films was analyzed at 60° and at 85° gloss by directly measure the coating surface at room temperature using a BYK Gardner Glossmeter (micro-tri-gloss) according to ASTM D₅₂₃. The data reported is an average based on 10 datapoints measured from different locations of the coating. All coated films were allowed to cure at room temperature (25° C.) and 50% humidity environment for 1 week before conducting the gloss test.

### Abrasion Resistance

Abrasion resistance (Sutherland Rub) was determined using a Sutherland® 2000™ Rub Tester at room temperature with 1.8 kg weight pad at a running speed of 2 according to ASTM of ASTM D-5264. All coated films were allowed to cure at room temperature (25° C.) and 50% humidity environment for 1 week before conducting the abrasion resistance test of coating to coating. The test data was recorded based on 100 cycles/read.

### Coefficient of Friction (COF)

The COF of the coated films was determined using a TMI Friction and Slip Tester Model 32-07-00 at 25° C. and 50% relative humidity according to the procedure described in ASTM D1894. The COF test was conducted by both coating to coating and coating to steel panel with a 200 g sled at 15 cm/min sliding speed with 5 cm travel distance. The COF data was collected from average of triplicate. Both static COF and Kinetic COF of coating to coating (C/C) and coating to steel (C/S) are measured.

### Soft Touch

The soft touch property comparison was conducted by human sensory panels in a sensory laboratory. Soft touch was determined by detecting the differences in hand feel perception when different laminated structures are compared.

### Heat Seal Resistance

The heat seal resistance of the coated films was evaluated by the V-Fold Heat Resistance Test with a heat sealer at a temperature of 205° C., a pressure of 2.76×10⁵ Pa, and a duration time of 1 s. After the films were heat sealed, the coated films were designated as “pass” or “fail” with “pass” meaning that no adhesion or no finish was removed or no gloss changed; and “fail” meaning that the films undesirably stacked together or the matte finish peeled off or the gloss changed.

### Tape Adhesion

A tape adhesion test was conducted with 3M Scotch 610 tape by applying, with finger pressure, the tape on the coating on a 2.5 cm length area, making sure that no air bubbles were formed in the adhesion area. Then, after a few seconds, the tape was pulled off from the coating adhesion area quickly; and the tape was observed to determine if any coating was peeled off from the substrate.

A rating system of numbers 1 to 5 is used to assess the adhesion property of the coated substrate by visually observing the amount of coating peeled off of the coated substrate. A rating of “1” means the amount of coating peeled off of the coated substrate with the tape is ≥90%; a rating of “2” means the amount of coating peeled off of the coated substrate with the tape is ≤60%; a rating of “3” means the amount of coating peeled off of the coated substrate with the tape is ≤20%; a rating of “4” means the amount of coating peeled off of the coated substrate with the tape is ≤10%; and a rating of “5” means the amount of coating peeled off of the coated substrate with the tape is essentially none or zero, i.e., no coating is peeled off the coated substrate with the tape.

### Glass Transition Temperature (Tg)

The Tg of the polymers herein are calculated herein by using the Fox equation (T. G. Fox. Bull. Am. Physics Soc, Volume 1, Issue No. 3, page 123 (1956)). That is, for calculating the Tg of a copolymer of monomers M₁ and M₂, the following general Equation (II) is used:

$$\frac{1}{Tg ( calc )} = \frac{w ( {M}_{1} )}{Tg ( {M}_{1} )} + \frac{w ( {M}_{2} )}{Tg ( {M}_{2} )} \qquad Equation ( II )$$

wherein Tg (calc) is the glass transition temperature calculated for the copolymer; w M₁) is the weight fraction of monomer M₁ in the copolymer; w(M₂) is the weight fraction of monomer M₂ in the copolymer; Tg(M₁) is the glass transition temperature of the homopolymer of M₁; and Tg(M₂) is the glass transition temperature of the homopolymer of M₂, all temperatures being in units of K.

The Tg of various monomers may be found, for example, in “Polymer Handbook”, edited by J. Brandrup and E. H. Immergut, Interscience Publishers.

### Malvern Particle Sizing Method for the Binder Emulsions

Particle sizes of the acrylic binder emulsions were measured using a Malvern Zetasizer Nano ZS90 Analyzer, which measures Z-average particle size (D_{z}) using dynamic light scattering (DLS) at a scattering angle of 90° using Zetasizer software version 7.11. A drop of the emulsion was diluted using an aqueous solution of 0.01 M NaCl (in ultrapure water, type 1, ISO 3696), and further diluted as needed to achieve a particle count in the range of 100-400 thousand counts/s (Kcps). Particle size measurements were carried using instrument's particle sizing method and D_{z} was computed by the software. D_{z} is also known as the intensity-based harmonic mean average particle size and expressed as in Equation (III);

$${D}_{Z} = \frac{\sum {S}_{i}}{\sum {(}^{{S}_{i}} {/}_{{D}_{i}} )} \qquad Equation ( III )$$

In the above Equation (III), Si is scattered intensity from particle i with diameter Dᵢ. Detailed D_{z} calculations are described in ISO 22412:2017 (Particle size analysis—Dynamic light scattering (DLS)).

Particle Size for the Acrylic beads

The particle size of the multistage crosslinked bead dispersions used in the coating formulation is measured using Disc Centrifuge Photosedimentometer (DCP, CPS Instruments, Inc., Prairieville, LA) that separates modes by centrifugation and sedimentation through a sucrose gradient. The samples were prepared by adding 1 drop to 2 drops of the bead dispersion into 10 mL of deionized (DI) water containing 0.1% sodium lauryl sulfate, followed by injection of 0.1 mL of the sample into a spinning disc filled with 15 g/mL of sucrose gradient. A 2% to 8% sucrose gradient disc spinning at 10,000 rpm was used, and 895-nanometers (nm) polystyrene calibration standard was injected prior to injection of the sample. The median weight average (D₅₀) particle size is determined.

### Solids Content

The solids content of the coating formulation and its individual components are measured by placing about 1 g wet dispersion on an aluminum pan and weight if recorded. The pan with the sample is then placed in 150° C. oven for 30 min. Pan with dry sample is weighted and the dry sample weight is recorded. Solids content is calculated as the ratio of the dry sample weight over wet sample weight using the following Equation (IV):

$$\% solids content = ( weight of the dry sample / weight of the wet sample ) ⋆ 100 \qquad Equation ( IV )$$

### Sample Preparation for AFM

The dispersion of acrylic beads was diluted with water to 1/20 (v/v) and casted on a freshly cleaved mica surface, and then let it dry in a paper covered petri-dish at room temperature for 3 days before AFM analysis.

### Surface Young's Modulus Measurement by AFM Using PF-QNM

Samples were analyzed utilizing Bruker Icon AFM system in PeakForce QNM which is based on PeakForce Tapping mode. In PeakForce Tapping, the probe was oscillated at 2,000 Hz frequency and a designated peak force (maximum nominal force applied to the sample) was used for feedback control. Each time the tip interacted with the sample, a force curve was collected and analyzed for nanomechanical properties. Only the force curves collected on the top of the beads were extracted for calculate Young's modulus using SPIP Image Processor Software (Image Metrology, Denmark). Table XI shows the parameters used in the examples discussed in this application.

TABLE XI
Parameters for PFQNM Force Curve Measurements.
Imaging Parameter (PF QNM)

| | |
|---|---|
| Probe type | RTESPA-300-30 |
| Spring constant | 43.67 Newtons/meter (N/m) |
| Deflection sensitivity | 51.7 nanometers/volt (nm/V) |
| Probe radius | 30 nanometers (nm) |
| Scan rate | 0.5 Hz |
| PF Setpoint | 400 nanonewtons (nN) |

Young's modulus was calculated according to DMT spherical indentation model (referenced from Derjaguin, B. V., V. M. Muller, and Y. P. Toporov, Effect of contact deformations on the adhesion of particles. Journal of Colloid and interface science, 1975. 53 (2): p. 314-326) as shown in the following general Equation (V):

$${F}_{DMT} = \frac{4}{3} \frac{E}{( 1 - {υ}^{2} )} \sqrt{{R}_{tip}} {( {S}_{m} - S )}^{3 / 2} - {F}_{pulloff} \qquad Equation ( V )$$

where E is the Young's modulus measured at the point of contact of the tip, v is the Poisson's ratio, Rₜᵢₚ is the tip radius, Sₘ-S is the indentation, and F_{pulloff} is pull off force.

The Young's modulus of Bead1 (3 μm in size) was compared to the Young's modulus of Bead4 (3 μm in size) at a frequency of 2,000 Hz. The Young's Modulus for Bead1 was 557 MPa compared to a Young's Modulus of 380 MPa for Bead4.

The results show that the 3 μm Bead1 has a higher surface modulus and thus has a less than 1 COF-C/C-Static. On the other hand, the 3 μm Bead4 has a lower surface modulus and thus has a greater than 1 COF-C/C-Static)

### Performance of Matte Coatings

The matte coatings from all of the Examples were disposed on a 12 μm thick PET film substrate and the performance of such coated films was measured. The results of such measurements are described in Table XII.

TABLE XII
Performance of Matte Coatings on 12 μm PET Film

| | Inv. Ex. | Inv. Ex. | Inv. Ex. | Inv. Ex. | Comp. Ex. | Comp. Ex. | Comp. Ex. | Comp. Ex. |
|---|---|---|---|---|---|---|---|---|
| Performance | 1 | 2 | 3 | 4 | A | B | C | D |
| Ratio of wet matte | 100/0.75 | 100/1.0 | 100/1.0 | 100/1.0 | 100/1.0 | 100/1.0 | 100/1.0 | 100/1.0 |
| coating/post-crosslinker | | | | | | | | |
| CR 9-101: | | | | | | | | |
| Coating weight (g/m²); | 1.22 | 1.38 | 1.42 | 1.37 | 1.42 | 1.95 | 1.95 | 1.79 |
| COF-C/C⁽¹⁾-Static: | 0.74 | 0.88 | 0.76 | 0.82 | 1.43 | 1.94 | 1.85 | 3.12 |
| COF-C/C-Kinetic: | 0.44 | 0.55 | 0.49 | 0.47 | 0.76 | 0.97 | 0.92 | 1.67 |
| COF-C/S⁽²⁾-Static: | 0.40 | 0.38 | 0.46 | 0.54 | 0.58 | 0.85 | 0.79 | 1.25 |
| COF-C/S-Kinetic | 0.33 | 0.31 | 0.35 | 0.37 | 0.44 | 0.54 | 0.56 | 0.71 |
| Abrasion* (Sutherland | >1,500 | >1,500 | >1,500 | >1,500 | >1,500 | >1,000; | >1,000; | <200 |
| rub, 1.8 kg weight load, | | | | | | <1,500 | <1,500 | |
| Speed#2: | | | | | | | | |
| Gloss 60°: | 9.9 | 8.6 | 8.7 | 8.6 | 9.0 | 9.2 | 9.4 | 11.6 |
| Gloss 85°: | 26.5 | 24.9 | 28.2 | 27 | 27.5 | 6.5 | 6.9 | 9.4 |
| Tape adhesion** | >5B | >5B | >5B | >5B | >5B | >5B | 5B | >5B |
| (Scott tape): | | | | | | | | |
| Thermal seal resistance | Pass, not | Pass, not | Pass, not | Pass, not | Pass, not | Pass, not | Pass, not | Pass, not |
| (205° C., C/C, V-Fold | sticky, no | sticky, no | sticky, no | sticky, no | sticky, no | sticky, no | sticky, no | sticky, no |
| heat resistance test): | coating | coating | coating | coating | coating | coating | coating | coating |
| | damage | damage | damage | damage | damage | damage | damage | damage |
| Soft touch***: | 5 | 5 | 5 | 5 | NT**** | 4 | 4 | 2 |

Notes
for Table XII: ⁽¹⁾“C/C” stands for “coating-to-coating”.
⁽²⁾“C/S” stands for “coating-to-steel”.
*test up to 1,500 cycles.
**1B-5B scale: “1B” = coating removed and “5B” = coating not damaged.
***Sensory Panel Test: “1” = worst and “5” = best.
****“NT” = not tested.

The matte coating from Inv. Ex. 2 was disposed on various film substrates with various film thicknesses and the performance of such coated film substrates was measured. The results of such measurements are described in Table XIII.

TABLE XIII
Performance of Matte Coating from Inv. Ex. 2 on Various Substrates

| | Substrate (Thickness) | | | |
|---|---|---|---|---|
| Performance | PET (12 μm) | HDPE (50 μm) | Nylon (25 μm) | BOPP (20 μm) |
| Ratio of wet matte coating/post- | 100/0.70 | 100/0.70 | 100/0.70 | 100/0.70 |
| crosslinker CR 9-101: | | | | |
| Coating weight (g/m²): | 2.25 | 2.38 | 2.54 | 2.21 |
| COF-C/C-Static: | 0.81 | 0.65 | 0.99 | 0.83 |
| COF-C/C-Kinetic: | 0.47 | 0.38 | 0.50 | 0.46 |
| COF-C/S-Static: | 0.59 | 0.50 | 0.59 | 0.53 |
| COF-C/S-Kinetic: | 0.41 | 0.37 | 0.41 | 0.39 |
| Abrasion* (Sutherland rub, 1.8 kg | >1,000 | >1,000 | >1,000 | <700 |
| weight load, Speed#2): | | | | |
| Gloss 60°: | 7.2 | 6.5 | 7.6 | 7.8 |
| Gloss 85°: | 26.6 | 29.3 | 20.0 | 27.4 |
| Tape adhesion** (3M Scotch 610 tape): | >5B | >5B | >5B | >5B |
| Thermal seal resistance (205° C., C/C, | Pass, | Pass, | Pass, | Pass, |
| V-Fold heat resistance test): | not sticky, | not sticky, | not sticky, | not sticky, |
| | no coating | no coating | no coating | no coating |
| | damage | damage | damage | damage |

Notes for Table XIII:
*test up to 1,000 cycle, no coating surface damage observed.
**1B-5B scale: “1B” = coating removed and “5B” = coating not damaged.

1. An aqueous matte finish coating formulation comprising (a) a plurality of first multistage crosslinked acrylic beads having a median weight average particle size of less than or equal to 4 microns and a surface Young's modulus of greater than or equal to 450 megapascals.

2. The formulation of claim 1, wherein the particles provide the formulation with a static coefficient of friction of coating to coating is less than 1.

3. The formulation of claim 1, further including (b) a plurality of second acrylic beads having a predetermined average particle size of greater than 0.2 micron to less than 1.0 micron.

4. The formulation of claim 1, further including (c) a binder.

5. The formulation of claim 4, wherein the binder is a third acrylic emulsion different from the first acrylic beads and the second acrylic beads; wherein the binder has a Tg of from −30° C. to 60° C.; and wherein the binder has an average z-average particle size of from 0.05 μm to 0.3 μm.

6. The formulation of claim 1, further including at least one of: (d) at least one rheology modifier; (e) at least one defoamer; (f) at least one neutralization agent to adjust the pH of the formulation to a level of from 7.5 to 9.0; (g) at least one wetting additive; (h) at least one slip additive; and (i) at least one water-dispersible post-crosslinker.

7. The formulation of claim 1, wherein the multistage crosslinked acrylic beads have a core-shell particle morphology with a first stage and second stage, wherein the first stage is a crosslinked core having a Tg of less than or equal to 20° C.; and wherein the second stage is grafted as a shell to the core, the shell having a Tg greater than or equal to 30° C.

8. A dry coating made from the formulation of claim 1.

9. A matte coated substrate, comprising (i) the dry coating of claim 8 disposed on the surface of (ii) at least one layer of a substrate.

10. The matte coated substrate of claim 9, wherein the substrate comprises at least one substate selected from the group consisting of films, sheets or containers of wood, metal, plastic, leather, paper, vinyl, woven textiles, nonwoven textiles, and combinations of two or more thereof.

11. A packaging article made from the matte coated substrate of claim 9.

12. A process of producing the aqueous matte finish coating formulation of claim 1 comprising the steps of:
(I) synthesizing a first acrylic bead dispersion having a median weight average particle size of less than or equal to 4 microns in diameter and a surface Young's modulus of greater than or equal to 450 megapascals;
(II) mixing the bead dispersion with an aqueous binder emulsion to form a pre-coating formulation;
(III) mixing the pre-coating formulation with an isocyanate post-crosslinker to form a matte coating formulation;
(IV) applying the matte coating formulation to a substrate to form a coating layer on the substrate; and
(1) curing, or allowing to cure, the coating layer to form an aqueous matte finish coating on the substrate.

13. (canceled)

14. (canceled)
